(19) United States
(12) Patent Application Publication
(10) Pub. No.: US 2014/0023051 A1
(43) Pub. Date: Jan. 23, 2014

(54) METHOD AND APPARATUS FOR ACCESSING IN AN EQUIPMENT OF A COMMUNICATION NETWORK

(71) Applicants: Yu Chen, Shanghai (CN); He Wang, Shanghai (CN); Hongfei Du, Shanghai (CN)

(72) Inventors: Yu Chen, Shanghai (CN); He Wang, Shanghai (CN); Hongfei Du, Shanghai (CN)

(73) Assignee: ALCATEL LUCENT, Paris (FR)

(21) Appl. No.: 14/009,003

(22) PCT Filed: Mar. 30, 2012
(86) PCT No.: PCT/IB2012/000905

§ 371 Date: Sep. 30, 2013

(30) Foreign Application Priority Data
Apr. 2, 2011 (CN) 201110084205.9

(51) Int. Cl. H04W 72/04

(52) U.S. Cl. CPC H04W 72/042
USPC 370/336

(57) ABSTRACT

A method of accessing in an equipment of a communication network is proposed in the invention. The method comprises the steps of: receiving a message 2 from a base station, the message 2 being used for an assignment of resource to transmit a message 3, the assigned resource corresponding to N HARQ RTTs, where 1≦N≦8; and transmitting the message 3 only in part of the N HARQ RTTs. With the scheme of the invention, a MTC device selectively transmits the Msg3 in one/some HARQ RTT and maintains silence in another one/some HARQ RTT, thus the possibility of the occurrence of access collision with other UEs may be backed off, such that other UEs, particularly human-to-human UEs, may transmit the Msg3 normally. And the possibility of the occurrence of collision is reduced from the viewpoint of the user equipments in a network, reducing entirely the possibility of an access delay and access failure.

### FIELD OF THE INVENTION

The invention is related to a communication network, particularly, to a method and apparatus for accessing in an equipment of a wireless communication network.

### BACKGROUND OF THE INVENTION

With the development of the Internet technology, the concept of Internet of Things becomes an important constitution of the new generation of information technology gradually. The network similar to the Internet of Things has two features: firstly, the core and base thereof are still the communication network, such as the mobile internet, i.e. a network extended and expanded on the basis of the Internet; secondly, the user end thereof extends and expands to information exchange and communication between any objects, but is not limited to the fact that the traditional user equipment is generally adapted to the information exchange and communication between human beings.

At present and in the future, the equipment to which many networks similar to the Internet of Things belongs, or referred as to a MTC (Machine Type Communication) device will conduct communication by the existing mobile Internet as a carrier network, such that the steps of the access and the communication of the session and connection of the communication of the MTC device above generally requires to be conducted in parallel with the traditional Human to Human type of UE (User Equipment, referred to as UE hereinafter), accordingly, the MTC device and the UE may be in the same network, and process the same signaling in parallel in the same manner.

### SUMMARY OF THE INVENTION

Based on the reference data from the operator, it is usually assumed that there may be 30000 MTC devices accessing the network within 10 seconds in a usual mobile network of 3GPP. This imposes great influence on the network. Taking an incoming retransmission after the collision into account, a severe impact on the performance of the system may be caused due to the access delay of about ten seconds or even longer. The result thus is that the access ability is decreased, and even worse, the access ability is consumed out and there is none UE or a few UE may access successfully in the access procedure thereof. This is more unacceptable for the UE in the network, because it performs the communication service between human beings.

Turn back to the fact that a typical scheme existing in 3GPP is a backoff, however, that scheme is proposed in the case that there is none of MTC device, and actually, with the prevalence of the Internet of Things, generally, the number of the MTC devices in the network may exceed that of is the UEs. Such scheme is not efficient in avoiding the decreasing of a human-to-human communication. Therefore, such scheme is required to be improved.

Because the user equipment transmits the 1^{st} message (Msg1) to an eNB and waits for the 2^{nd} message (Msg2) from the eNB on a channel in the communication access of the user equipment used at present. The Msg2 will arrive in a window of one or more (e.g. 5) subframes. By now, the eNB have not known whether there is a collision or not. In the Msg2, the eNB indicates to the user equipment the time and frequency resources that are used to transmit the Msg3. However, for the Msg3, a collision of Msg3 occurs, since the respective messages are transmitted on the same resources by different user equipments. However, the Msg3 can not be decoded on the side of the eNB, thus the eNB transmits a NACK to the user equipment, and next, the Msg3 is transmitted by the user equipment repeatedly until the maximum number of the permitted transmissions/retransmissions of the Msg3 is reached. Next, the user equipment will return back to the initial point of the access procedure and transmit the Msg1 again after a period of backoff time.

It is realized by study that the longest delay of the user equipment results from the retransmission of the Msg3 in the access procedure above. A delay of 40 ms will be introduced if it is assumed that 5 retransmissions is allowed for the Msg3 according to the above example. If that user equipment still collides with other user equipments for communication after that delay, an access procedure will begin again, which will introduce a delay of hundreds of milliseconds.

It is realized by study that one of the reasons to the above problem is that the eNB cannot detect the collision. However, the bottleneck for the decreasing of the access efficiency and the adverse impact on the performance of the UE is due to the access collision occurred in the 3rd message (Msg3) in the access procedure, in the network in which there coexist numerous MTC devices and UEs, provided that the above flow is executed by all user equipments (including the MTC device and the UE). When two or more UEs select the same access preamble, then they may receive the same signaling, i.e., the 2nd message (Msg2), in order to indicates the resources for transmitting the Msg3, and the Msg3 is transmitted on the same resources. When the collision occurs, the eNB can not detect the Msg3 from each UE or MTC device correctly, therefore, the UE or the MTC device conducts a retransmission of the Msg3, until a maximum Msg3 transmission limit is reached.

Against the drawbacks existing in the related art, if a method for accessing in an equipment of a communication network is proposed, by which the success ratio in the access procedure for a human-to-human type of UE can be improved and the access delay time of the MTC device or the UE in the network can be reduced in the network where there coexist the MTC device and the UE, then it will be advantageous and desirable in terms of the communication performance of the network.

Therefore, a method for accessing in an equipment of a communication network is proposed in an embodiment of the invention in accordance with the above analysis and research. The method comprises the steps of:

receiving a message 2 from a base station, the message 2 being used for assigning the resource to transmit a message 3, the assigned resource corresponding to N HARQs (Hybrid Automatic Repeat Request) RTT (round trip time), where 1 [symbol] N [symbol] 8; and only transmitting the message 3 in part of the N HARQ RTTs.

There may be a plurality of methods for the selection of part of HARQ RTTs for transmitting message 3 among N HARQ RTTs in the method of the above embodiment. Optionally, silence is maintained automatically, for example, in the 1^{st} or 2^{nd} HARQ RTT of the MTC device, i.e., the Msg3 is not transmitted, if it is in the access flow, in order to avoid the collision with the other human-to-human type of UEs which may exist. Optionally, the message 3 of the access procedure may also be transmitted selectively in the N HARQ RTTs in accordance with a predetermined probability, for example, 0.7.

In the schemes of some embodiments of the invention, a MTC device selectively transmits a Msg3 in one/some HARQ RTT and maintains silence in another one/some HARQ RTT, thus the possibility of the occurrence of access collision with other UEs may be backed off, such that other UEs, particularly human-to-human UEs, may transmit the Msg3 normally, and the probability of the occurrence of collision is reduced from the viewpoint of the user equipments in a network, reducing entirely the possibility of an access delay and access failure. In some embodiments of the invention, the MTC device maintains silence automatically in the first one or more HARQ RTTs of the timing of the N HARQ RTTs, such that the first one or more HARQ RTTs on such timing may be used by other user equipments in the same network, particularly, the human-to-human type of UEs, to complete the access in priority, so that the access procedure of the human-to-human type of UE in the network is not affected in the case where numerous MTC devices are added in the network.

### BRIEF DESCRIPTION OF DRAWINGS

The feature, object and advantage of the invention will be more apparent by reading the detailed description made for the unlimited embodiments with reference to the drawings.

FIG. 1 is a message flow chart of an access procedure of a communication network system in accordance with an embodiment of the invention;

FIG. 2 is a method flowchart for accessing in an equipment of the communication network in accordance with an embodiment of the invention;

FIG. 3 is a flowchart of step S202 of the access method as shown in FIG. 2 in accordance with another embodiment of the invention;

FIG. 4 is a structural diagram of an apparatus for accessing in the equipment of the communication network in accordance with another embodiment of the invention;

Where like or similar reference numbers indicate like or similar step is features and apparatus (module).

### DETAILED DESCRIPTION OF EMBODIMENTS

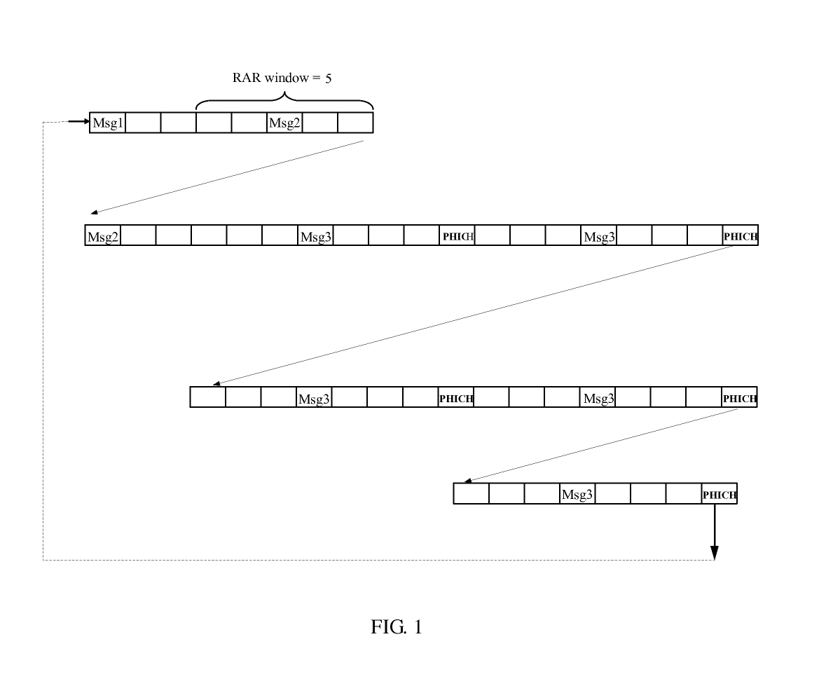

FIG. 1 is a message flow chart of an access procedure of a communication network system in accordance with an embodiment of the invention. In the access flow of the user equipment (including a MTC device and a human-to-human type of UE), as shown in the figure, from the perspective of timing, the user equipment transmits the 1^{st} message (Msg1) to an eNB and waits for the 2^{nd} message (Msg2) from the eNB on a channel. The Msg2 will arrive in a window (RAR window) of one or more (e.g. 5) subframes. By now, the eNB (not shown in the figure) have not known whether there is a collision or not. In the Msg2, the eNB indicates to the user equipment the time and frequency resource which should be used to transmit the Msg3. However, in accordance with 3GPP protocol, for the Msg3, the respective messages may be transmitted on the same time and frequency resource by different user equipments, thus a Msg3 collision may be occur, however, in such collision, the Msg3 can not be decoded on the side of the eNB, accordingly, the eNB transmits a NACK to the user equipment, and next, the Msg3 is transmitted on the same time and frequency resource by the user equipment repeatedly up to a maximum number of the permitted transmissions/retransmissions of the Msg3. In the embodiment, it is assumed that the maximum number of the permitted transmissions/retransmissions corresponding to the Msg3 is 5, as shown in the figure, and of course, the maximum number of the permitted transmissions/retransmissions may also be configured to be any value among 1 to 8. Next, the user equipment will return back to the initial point of the access procedure and transmit the Msg1 again after a period of backoff time.

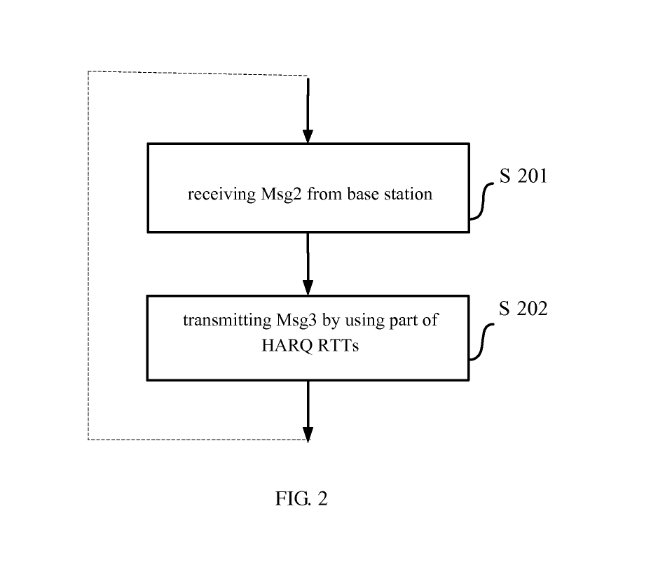

A detailed description is made for some embodiments of the invention in connection to FIGS. 1 and 2. In those embodiments, the MTC device is used as the subject to execute some methods for accessing in the embodiment of the invention primarily, however, those skilled in the art will recognize that is the method may also be used in other types of user equipments, for example, a general human-to-human type of UE (referred to be as a UE hereinafter), or for example, may also be used in the procedure in which numerous human-to-human type of UEs access the system concentratedly.

FIG. 2 is a method flowchart for accessing in an equipment of the communication network in accordance with an embodiment of the invention. As shown in the figure, the access method of the embodiment includes step S201 of receiving a Msg2 from a base station, and step S202 of transmitting a Msg3 by using part of HARQ RTTs.

In step S201, the MTC device receives the message 2 from the base station. The message 2 is used for an assignment of the time and frequency resource to transmit the message 3, and the assigned time and frequency resource corresponds to N HARQ RTTs, where 1 [symbol] N [symbol] 8.

Next, in step S202, the MTC device transmits the message 3 only in part of the N HARQ RTTs.

Taking N=5 as an example, in the scheme of the related art, in 5 HARQ RTTs, the Msg3 is transmitted continuously in the current HARQ RTT, if the response corresponding to the previous HARQ RTT received by the MTC device on PHICH (Physical hybrid-ARQ indicator channel) is a NACK, and there is not any backoff action in the access procedure, that is, in the access procedure, the MTC device will not select to maintain silence automatically.

In the embodiment of the invention, the MTC device may not transmit the Msg3 in current HARQ RTT, and select to transmit the Msg3 continuously in accordance with a decision of the communication situation or select to maintain silence, if the received response corresponding to the previous HARQ RTT is a NACK. In other words, in an access procedure, the message 3 is transmitted only in part of the all 5 HARQ RTTs by MTC device. For example, the Msg3 is transmitted in the 2^{nd} and 5^{th} HARQ RTTs, if the received feedbacks corresponding to the 1^{st} and 4^{th} HARQ RTTs are NACK, and silence is maintained in the remaining HARQ RTTs, even though the is received feedback corresponding to the previous HARQ RTT is a NACK. Of course, silence may be selected automatically without any requirement in the first HARQ RTT.

Optionally, in the method of the embodiment, it may further comprise a step of receiving a system information block message from a base station. The system information block message includes transmission control information corresponding to the message 3 for indicating how the equipment selects part of HARQ RTTs among the 5 HARQ RTTs to transmit the message 3.

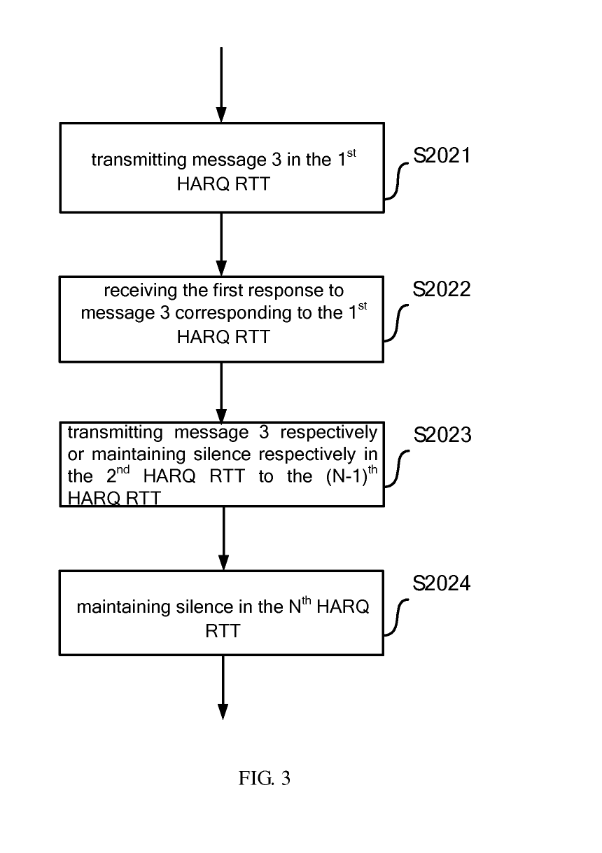

FIG. 3 is a flowchart of step S202 of the access method as shown in FIG. 2 in accordance with another embodiment of the invention. As shown in the figure, step S202 of the access method of the embodiment further comprises step S2021 of transmitting the message 3 in the 1^{st} HARQ RTT, step S2022 of receiving a first response to the message 3 corresponding to 1^{st} HARQ RTT, step S2023 of transmitting the message 3 respectively or maintaining silence respectively in the 2^{nd} HARQ RTT to the (N−1)^{th} HARQ RTT, and step S204 of maintaining silence.

In step S2021, the message 3 is transmitted in the 1^{st} HARQ RTT of the 5 HARQ RTTs by the MTC device.

Next, in step S2022, a first response to the message 3 corresponding to the 1^{st} HARQ RTT is received on PHICH by the MTC device.

Next, a decision is made in step S2023, message 3 is transmitted respectively or silence is maintained respectively, for example, in the 2^{nd} HARQ RTT to the 4^{th} HARQ RTT of the 5 HARQ RTTs in accordance with the first predetermined probability, if the received first response is a NACK in step S2022.

Next, in step S2024, the last of the 5 HARQ RTTs is selected, i.e., silence is maintained in the 5^{th} HARQ RTT.

Optionally, the first predetermined probability above in the embodiment may be obtained based on the ID of the equipment modulo divided by 3, then in accordance with the computation result of modulo is division, the MTC device of the embodiment either transmits the message 3 in the 2^{nd} HARQ RTT to the 4^{th} HARQ RTT, or maintains silence in the 2^{nd} HARQ RTT to the 4^{th} HARQ RTT. However, statistically, in the case where there are numerous MTC devices required to conduct access, there may be about 33% of the MTC devices maintain silence on each HARQ occasion, then the access performance of the system may be improved and the access delay may be decreased with a ratio related to it. From the viewpoint of the probability, the MTC device may transmit the message 3 in all of the 1^{st} to the 4^{th} HARQ RTTs in the embodiment, therefore, in step S2024, the MTC device selects to maintain silence, which can ensure there is an HARQ RTT in that access procedure, in which the MTC device maintains silence to backoff the possible collision occurrence.

Of course, those skilled in the art shall be appreciated that if the result of the decision made in step S2023 shows the first response received in step S2022 is an ACK, then the MTC device accesses successfully at this time, and steps S2023 and S2024 thereafter are not necessary to be conducted. This is also adapted to the embodiments hereinafter, and omitted for simplicity.

In another embodiment of the invention, the above S202 step may further comprise the steps of: a step of transmitting the message 3, a step of receiving the response, and a step of maintaining silence.

In “the step of transmitting message 3”, the MTC device transmits the message 3 only in the m^{th} HARQ RTT of the N HARQ RTTs.

In “the step of receiving the response”, a first response to the message 3 corresponding to the m^{th} HARQ RTT is received on PHICH by the MTC device.

In “the step of maintaining silence”, the MTC device maintains silence m in the (m+1)^{th} HARQ RTT, if the first response is a NACK.

Herein, those skilled in the art will understand that the value of m cannot be greater than 7 significantly in the 3 steps above, i.e., the maximum of m is 7 in the steps of the method of the embodiment, for 1 [symbol] N [symbol] 8. In other words, the above method should be used in a system with N [symbol] 2.

Optionally, the method of above embodiment may further comprise the two steps of (a) the MTC device receiving a second response to the message 3 corresponding to the (m+1)^{th} HARQ RTT on PHICH, and (b) the MTC device transmitting the message 3 in the (m+2)^{th} HARQ RTT, if the second response is a NACK.

Herein, those skilled in the art will understand that the value of m cannot be greater than 6 significantly in the 3 steps above, i.e., the maximum of m is 7 in the steps of the method of the embodiment, for 1 [symbol] N [symbol] 8. In other words, the above method should be used in a system with N [symbol] 3.

Optionally, the value of m above may be 1, in other words, the MTC device selects to transmit the message 3 in the 1st HARQ RTT, and maintains silence on the 2^{nd} HARQ RTT to backoff the collision if the received corresponding response is a NACK, next, retransmits the message 3 in the 3rd HARQ RTT if the received corresponding response is still a NACK.

In addition, for the system of which the configuration coefficients does not satisfy the above conditions, the method of the embodiment below of the invention may be considered to be adopted, i.e. selecting one or more HARQ RTTs among all the N HARQ RTTs to transmit message 3 in accordance with a predetermined probability.

In yet another embodiment of the invention, the above S202 step may further comprise the steps of (a) transmitting the message 3, (b) receiving the response, and (c) transmitting selectively.

In step (a), the message 3 is transmitted in the 1^{st} HARQ RTT of the N, e.g., 5, HARQ RTTs by the MTC device. Particularly, on a specific transmission period in the HARQ RTT, for example, on the corresponding HARQ occasion within that HARQ RTT. The description of the specific transmission moment for messages such as Msg3 and so on will be omitted hereinafter.

In step (b), a first response to the message 3 corresponding to the 1^{st} HARQ RTT is received on PHICH by the MTC device.

In step (c), the MTC device selects one HARQ RTT among the 2nd is HARQ RTT to the N^{th} HARQ RTT of 5 HARQ RTTs to transmit the message 3 in accordance with the first predetermined probability, if the first response is a NACK.

Herein, those skilled in the art will understand that the method of the embodiment should be used in a system with N [symbol] 2. The first predetermined probability therein may be configured by those skilled in the art in accordance with the requirement of the application situation, e.g., may be 0.7 or 0.8, etc. In accordance with the selective characteristics of step (c), from the viewpoint of timing, once an HARQ RTT for transmitting the Msg3 is determined by the above probability among 2^{nd} HARQ RTT to the 5^{th} HARQ RTT, the subsequent HARQ RTTs are not necessary to be decided, and all of them maintain silence.

In the embodiment, step (c) of transmitting selectively further comprises two sub-steps (c1) and (c2), in order to achieve the selection of one HARQ RTT between the 2^{nd} HARQ RTT and the 3^{rd} HARQ RTT to transmit the Msg3.

In step (c1), the MTC device maintains silence in the 3^{rd} HARQ RTT, if the 2^{nd} HARQ RTT is selected to transmit the message 3 in accordance with the first predetermined probability, and the second response of the message 3 corresponding to the 2^{nd} HARQ RTT received on PHICH is a NACK.

In step (c2), the MTC device transmits the message 3 in the 3^{rd} HARQ RTT, if it is determined to maintain silence in the 2^{nd} HARQ RTT in accordance with the first predetermined probability, and the second response to the message 3 corresponding to the 2^{nd} HARQ RTT received on PHICH is a NACK.

In yet another embodiment of the invention, the S202 step above may further comprises the steps of (d) maintaining silence, (e) receiving the response, and (f) transmitting the message 3.

In step (d), silence is maintained in the 1^{st} HARQ RTT of the N, e.g., 5, HARQ RTTs by the MTC device.

In step (e), a first response to the message 3 corresponding to the 1st is HARQ RTT is received on PHICH by the MTC device.

In step (f), the MTC device transmits the message 3 in the 2^{nd} HARQ RTT of all the 5 HARQ RTTs, if the first response is a NACK.

Herein, those skilled in the art will understand that the method of the embodiment should be used in a system with N [symbol] 2. In addition, notably, although the Msg3 is not transmitted in step (d) by the MTC device, it indicates there have been other user devices completing the step in the access procedure thereof through the corresponding time and frequency resource after the backoff of step (d) by the MTC device, if the first response to the message 3 corresponding to the 1^{st} HARQ RTT received by the MTC device in step (e) is ACK. In that case, the MTC device may wait for a predetermined time of backoff, e.g., 20 ms, and then re-access, in turn to perform steps S201 and S202 etc., which will be omitted herein for simplicity.

In yet another embodiment of the invention, the above S202 step may further comprise a step of step (g) of transmitting the Msg3 according to a probability. In such step, the MTC device transmits the message 3 selectively in the configured N HARQ RTTs in accordance with the second predetermined probability. The second probability may be different as the values of N are different. For the situation where N is configured to be smaller, the value may be larger accordingly, for example, if N=2, then value of the second probability may be 0.41. The value of the second probability may be smaller, e.g., 0.25, if the value of N is larger, e.g., N=5, such that the opportunity of the occurrence of the collision of the MTC device with the other user equipments is controlled to some extent.

Hereinafter, a plurality of methods in the embodiment of the invention above may be applied to an experiment of the practical communication network. The system parameters of the experiment are shown in Table 1 as follows, of which the parameters satisfy the requirement of 3GPP standard.

TABLE 1
Basic Parameter Configuration of LTE FDD

| parameter | setting |
|---|---|
| Number of MTC devices | 10000, 30000 |
| Access distribution of MTC device | Beta distribution over 10s |
| Cell bandwidth | 5 MHz |
| PRACH configuration index | 6 |
| Total number of preambles | 54 |
| Maximum number of preamble | 10 |
| transmission | |
| Number of uplink grants per RAR | 3 |
| Number of CCEs allocated for PDCCH | 16 |
| Number of CCE per PDCCH | 4 |
| Preamble detection probability (in case of no collision) | $1 - \frac{1}{{e}^{i}}$ |
| | where i indicates the i^{th} preamble |
| | transmission |
| RA-response window size | 5 subframes |
| MAC-Contention Resolution timer | 48 subframes |
| Backoff indicator | 20 ms |
| HARQ retransmission probability for | 10% |
| Msg3 and Msg4 (non-adaptive HARQ) | |
| for the non-adaptive HARQ, maximum | 5 |
| number of HARQ transmission for Msg3 | |
| and Msg4 | |

wherein, based on the following two basic schemes in 3GPP:

(1) Backoff, as above, the UE will choose to back off a specific time, e.g., 20 ms, after each access failure.

(2) The UE may access the system in specific subframe in a slot based on mod(UE_ID, slot_length).

The method in the embodiment of the invention may be well compatible and adapted with above basic schemes proposed in 3GPP, because the method of the embodiment of the invention executes the 3^{rd} or 4^{th} access step, i.e., a contention resolution phase, while the basic schemes are for the first step, i.e., when to transmitting the preamble.

In that experiment, it is assumed that 30000 MTC devices access the system within 10 s. The effects of the 5 methods in accordance with the embodiment of the invention are shown in Table 2. Where a gain effect from is 80.88% to 99.24% is achieved in terms of the success rate of the access of the H2H UE in those variation of the invention with respect to the basic schemes in the related art. Meanwhile, the success ratio of the access of the MTC device is improved greatly. And the access of the success ratio results in the fact that the collision probability is reduced almost to a half. The access delay of the MTC device and H2H UE is decreased significantly. Particularly for the H2H UE, the delay is decreased from 199 ms to 49 ms. Meanwhile, the method in the embodiment of the invention will never waste the time and frequency resource. The total number of access attempts is reduced greatly due to less collision occurrence and higher success ratio of access, thus the average number of the Msg3 transmitted by the MTC device in the following Table is decreased from 9.08 to 4.23. Accordingly, the number of the preamble transmissions is also reduced from about 9 to 6.

TABLE 2
The effects of the 5 methods in accordance with the
embodiment of the invention

| | | | | | | average |
|---|---|---|---|---|---|---|
| | | | | | average | number of |
| | success | | | | MTC | Msg3 |
| | ratio of | success | | 90% H2H | device | transmitted |
| | MTC | ratio of | collision | delay | delay | by MTC |
| | device | H2H | probability | (ms) | (ms) | device |
| basic | 84.7% | 80.88% | 21.11% | 199 | 5.76e+3 | 9.08 |
| configuration | | | | | | |
| (Slot 256) | | | | | | |
| backoff at the | 83.28% | 98.77% | 20.74% | 49 | 5.82e+3 | 10.16 |
| 1^{st} HARQ RTT | | | | | | |
| backoff at the | 84.93% | 98.58% | 20.8% | 72 | 5.75e+3 | 9.1 |
| 2^{nd} HARQ | | | | | | |
| RTT | | | | | | |
| backoff at the | 97.78% | 98.62% | 15.71% | 87 | 4.75e+3 | 6 |
| 2^{nd} or 3^{rd} | | | | | | |
| HARQ RTT | | | | | | |
| backoff at the | 99.62% | 99.24% | 13.16% | 59 | 3.95e+3 | 4.62 |
| 2^{nd}, 3^{rd} or 4^{th} | | | | | | |
| HARQ RTT, | | | | | | |
| and backoff at | | | | | | |
| the 5^{th} HARQ | | | | | | |
| RTT | | | | | | |
| simultaneously | | | | | | |
| backoff at the | 99.88% | 98.61% | 12.48% | 115 | 3.66e+3 | 4.23 |
| 1^{st} to 5^{th} | | | | | | |
| HARQ RTT in | | | | | | |
| accordance | | | | | | |
| with | | | | | | |
| probability | | | | | | |

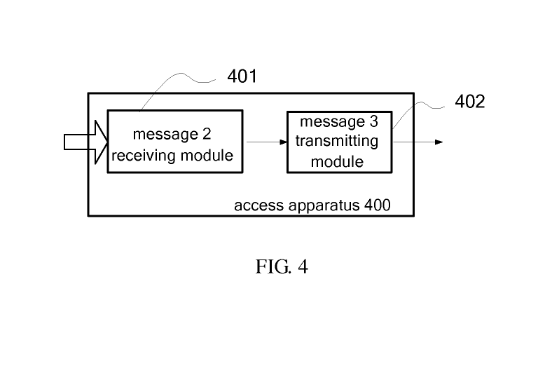

FIG. 4 is a structural diagram of an apparatus for accessing in the equipment of the communication network in accordance with another embodiment of the invention. The access apparatus 400 comprises a message 3 transmitting module 402 and a message 2 receiving module 401.

In the message 2 receiving module 401, the MTC device receives the message 2 from the base station. The message 2 is used for an assignment of the time and frequency resource to transmit the message 3, and the assigned time and frequency resource corresponds to N HARQ RTTs, where 1 [symbol] N [symbol] 8. Next, in the message 3 transmitting module 40, the MTC device transmits the message 3 only in part of the N HARQ RTTs.

Taking N=5 as an example, in the scheme of the related art, in 5 HARQ RTTs, the Msg3 is transmitted continuously in the current HARQ RTT, if a response corresponding to the previous HARQ RTT received by the MTC is device on PHICH (Physical hybrid-ARQ indicator channel) is NACK, and there is not any backoff action in the access procedure, that is, in the access procedure, the MTC device will not select to maintain silence automatically.

In the embodiment of the invention, the MTC device may not transmit the Msg3 in current HARQ RTT, and select to transmit the Msg3 continuously in accordance with a decision of the communication situation or select to maintain silence, if the received response corresponding to the previous HARQ RTT is a NACK. In other words, in an access procedure, the message 3 is transmitted only in part of the all 5 HARQ RTTs by MTC device. For example, the Msg3 is transmitted in the 2^{nd} and 5^{th} HARQ RTTs, if the received feedbacks corresponding to the 1^{st} and 4^{th} HARQ RTTs are NACK, and silence is maintained in the remaining HARQ RTTs, even though the received feedback corresponding to the previous HARQ RTT is a NACK. Of course, silence may be selected automatically without any requirement in the first HARQ RTT.

In another embodiment of the invention, the message 3 transmitting module 402 above further comprises four modules A, B, C, and D communicatively coupled to the MTC device.

A: a 1^{st} HARQ occasion transmitting module for transmitting the message 3 only in the 1^{st} HARQ RTT of all the 5 HARQ RTTs.

B: a response receiving module for receiving a first response to the message 3 corresponding to the 1^{st} HARQ RTT on PHICH.

C: a probability transmitting module for transmitting message 3 respectively or maintaining silence respectively, for example, in the 2nd HARQ RTT to the 4^{th} HARQ RTT of the 5 HARQ RTTs in accordance with is the first predetermined probability, if the received first response is a NACK in step S2022.

D: a tail HARQ occasion silence maintenance module for maintaining silence in the last of the 5 HARQ RTTs, i.e., the 5^{th} HARQ RTT.

Optionally, the first predetermined probability in the embodiment may be obtained based on the ID of the equipment modulo divided by 3 by the probability transmitting module C or other modules, then in accordance with the computation results of modulo division, the probability transmitting module C in the embodiment either transmits the message 3 in the 2^{nd} HARQ RTT to the 4^{th} HARQ RTT, or maintains silence in the 2^{nd} HARQ RTT to the 4^{th} HARQ RTT. However, statistically, in the case where there are numerous MTC devices required to conduct access, there may be about 33% of the MTC devices maintain silence on each HARQ occasion due to the effect of the probability transmitting module, then the access performance of the system may be improved and the access delay may be decreased with a ratio related to it. From the viewpoint of the probability, the probability transmitting module may transmit the message 3 in the transmission occasions of all the 1^{st} to the 4^{th} HARQ RTTs in the embodiment, therefore, the tail HARQ occasion silence maintenance module D is used for maintaining silence, which can ensure there is a HARQ RTT in that access procedure, in which the tail HARQ occasion silence maintenance module D maintains silence to backoff the possible collision occurrence.

In yet another embodiment of the invention, the message 3 transmitting module 402 may further comprises a second probability Msg3 transmitting module for transmitting the message 3 selectively in the configured N HARQ RTTs in accordance with the second predetermined probability. Where the second probability may be different as the values of N are different. For the situation where N is configured to be smaller, the value may be larger accordingly, for example, if N=2, then value of the second probability may be 0.41. The value the second probability may be smaller, e.g., 0.25, if the value of N is larger, e.g., N=5, such that the opportunity of is the occurrence of the collision of the MTC device in which the message 3 transmitting module 402 is located with the other user equipments is controlled to some extent.

Those skilled in this art will understand that respective apparatuses referred in the invention may be realized by hardware or functional modules in software, and the hardware modules integrated with the functional modules of software.

Those skilled in this art will understand that the above embodiment are all illustrative and not limit. Different technical features presented in different embodiments may be combined to achieve advantage effect. Those skilled in the art will understand and implement other variations of the disclosed embodiment based on the study of Drawings, Description and Claims. In Claims, term “comprise” does not exclude other apparatuses and steps; indefinite article “a” does not exclude the plurality; terms “the first” and “the second” are used to indicate names and not to indicates any specific order. Any reference number in the claims will not be regard as the limitation to the protective scope. The functions of a plurality of parts in the claims may be implemented by single hardware or software. The presence of some technical features in different dependent claims does not imply that those technical features can not be combined to achieve advantage effect.

1. A method of accessing in an equipment of a communication network, the method comprising:
receiving a message 2 from a base station, the message 2 being used for an assignment of resource to transmit a message 3, the assigned resource corresponding to N HARQ round trip times, where 1≦N≦8;
transmitting the message 3 only in part of the N HARQ round trip times.

2. The method in accordance with claim 1, wherein transmitting further comprises:
transmitting the message 3 in the m^{th} HARQ round trip time of the N HARQ round trip times;
receiving a first response to the message 3 corresponding to the m^{th} HARQ round trip time on a PHICH;
maintaining silence in the (m+1)^{th} HARQ round trip time, if the first response is a NACK.

3. The method in accordance with claim 2, wherein the method further comprises:
receiving a second response to the message 3 corresponding to the (m+1)^{th} HARQ round trip time on a PHICH;
transmitting the message 3 in the (m+2)^{th} HARQ round trip time, if the second response is a NACK.

4. The method in accordance with claim 3, wherein the value of m is 1.

5. The method in accordance with claim 1, wherein transmitting further comprises:
transmitting the message 3 in the 1^{st} HARQ round trip time of the N HARQ round trip times;
receiving a first response to the message 3 corresponding to the 1^{st} HARQ round trip time on a PHICH;
transmitting the message 3 in a HARQ round trip time that is selected among the 2^{nd} HARQ round trip time to the N^{th} HARQ round trip time of the N HARQ round trip times in accordance with a first predetermined probability, if the first response is a NACK.

6. The method in accordance with claim 5, wherein selectively transmitting further comprises:
maintaining silence in the 3^{rd} HARQ round trip time, if the 2^{nd} HARQ round trip time is selected in accordance with the first predetermined probability to transmit the message 3 and the second response to the message 3 correspond to the 2^{nd} HARQ round trip time received on the PHICH is the NACK;
transmitting the message 3 in the 3^{rd} HARQ round trip time, if it is determined in accordance with the first predetermined probability to maintain silence in the 2^{nd} HARQ round trip time and the second response to the message 3 corresponding to the 2^{nd} HARQ round trip time received on the PHICH is the NACK.

7. The method in accordance with claim 1, wherein transmitting further comprises:
transmitting the message 3 in the N HARQ round trip times selectively in accordance with the second predetermined probability.

8. The method in accordance with claim 1, wherein transmitting further comprises:
maintaining silence in the 1^{st} HARQ round trip time of the N HARQ round trip times;
receiving a first response to the message 3 corresponding to the 1^{st} HARQ round trip time on a PHICH;
transmitting the message 3 in the 2^{nd} HARQ round trip time of the N HARQ round trip times, if the first response is a NACK.

9. The method in accordance with claim 1, wherein transmitting further comprises:
transmitting the message 3 in the 1^{st} HARQ round trip time of the N HARQ round trip times;
receiving a first response to the message 3 corresponding to the 1^{st} HARQ round trip time on a PHICH;
transmitting the message 3 respectively or maintaining silence respectively in the 2^{nd} HARQ round trip time to the (N−1)^{th} HARQ round trip time of the N HARQ round trip times in accordance with the first predetermined probability, if the first response is a NACK;
maintaining silence in the N^{th} HARQ round trip time of the N HARQ round trip times.

10. The method in accordance with claim 9, wherein the first predetermined probability is obtained based on the ID of the equipment modulo divided by 3.

11. The method in accordance with claim 1, wherein the method further comprises:
receiving a system information block message from the base station, the system information block message including transmission control information corresponding to the message 3 for controlling the equipment to transmit the message 3 only in the part of the N HARQ round trip times.

12. An apparatus for accessing in an equipment of a communication network, the apparatus comprising:
a message 2 receiving module for receiving a message 2 from a base station, the message 2 being used for an assignment of resource to transmit a message 3, the assigned resource corresponding to N HARQ round trip times, where 1≦N≦8;
a message 3 transmitting module for transmitting the message 3 only in part of the N HARQ round trip times.

13. The apparatus in accordance with claim 12, wherein the message 3 transmitting module further comprises:
a first HARQ round trip time transmitting module for transmitting the message 3 in the 1^{st} HARQ round trip time of the N HARQ round trip times;
a first HARQ round trip time response receiving module for receiving a first response to the message 3 corresponding to the 1^{st} HARQ round trip time on a PHICH;
a second possibility transmitting module for transmitting the message 3 respectively or maintaining silence respectively in the 2^{nd} HARQ round trip time to the (N−1)^{th} HARQ round trip time of the N HARQ round trip times in accordance with the first predetermined probability, if the first response is a NACK.
a silence enabling module for maintaining silence in the N^{th} HARQ round trip time of the N HARQ round trip times.

14. The apparatus in accordance with claim 13, further comprising:
a probability obtaining module for obtaining the first predetermined possibility based on the ID of that equipment modulo divided by 3.

15. The apparatus in accordance with claim 12, wherein the message 3 transmitting module further comprises:
a selective transmitting module for transmitting the message 3 in the N HARQ round trip times selectively in accordance with the second predetermined probability.
